(19) United States
(12) Patent Application Publication
(10) Pub. No.: US 2026/0285402 A1
(43) Pub. Date: Sep. 24, 2026

(54) MOBILE OBJECT CONTROL DEVICE, MOBILE OBJECT CONTROL METHOD, AND PROGRAM

(71) Applicant: HONDA MOTOR CO., LTD., Tokyo (JP)

(72) Inventors: Masashi Fujita, Tokyo (JP); Yoshinori Izumi, Tokyo (JP); Takuya Tobe, Tokyo (JP); Yuki Yamamoto, Tokyo (JP)

(21) Appl. No.: 19/454,476

(22) Filed: Jan. 21, 2026

(30) Foreign Application Priority Data
Mar. 19, 2025 (JP) 2025-046031

(51) Int. Cl. B62D 15/02

(52) U.S. Cl. CPC B62D 15/025

(57) ABSTRACT

A mobile object control device improves the fault tolerance of an autonomous steering control mechanism while suppressing an increase in cost. The mobile object control device includes a recognition part configured to recognize a surrounding situation of a mobile object, a first steering control device configured to control steering of the mobile object, and a second steering control device configured to control the steering of the mobile object in place of the first steering control device. The first steering control device controls the steering of the mobile object so that a lane in which the mobile object is traveling is kept based on external environment information indicating a result of recognizing the surrounding situation in the recognition part. The second steering control device controls a steering device for implementing the steering of the mobile object based on predicted information predicted in relation to the steering of the mobile object.

### CROSS-REFERENCE TO RELATED APPLICATION

Priority is claimed on Japanese Patent Application No. 2025-046031, filed Mar. 19, 2025, the content of which is incorporated herein by reference.

### BACKGROUND OF THE INVENTION

### Field of the Invention

The present invention relates to a mobile object control device, a mobile object control method, and a program.

### Description of Related Art

Recently, efforts to provide access to sustainable transportation systems have been increasingly active in consideration of vulnerable individuals among participants in transportation. For this realization, research and development efforts are focused on further improving the safety and convenience of transportation through research and development related to autonomous driving technology. In this regard, conventionally, research has been conducted into technologies that enable a mobile object to maintain a travel direction even if an abnormality occurs in an autonomous steering control mechanism while the mobile object is traveling along an arc-shaped path.

For example, Patent Document 1 (Japanese Patent No. 7200210) discloses technology for selectively executing first steering control for controlling steering of a mobile object based on a movement situation of the mobile object and second steering control that is traveling control at the occurrence of a failure and that limits the steering of the mobile object based on a steering state of the mobile object under the first steering control before the occurrence of the failure.

### SUMMARY OF THE INVENTION

However, in conventional autonomous driving technologies, because abnormalities in an electronic control unit (ECU) are considered, but abnormalities in peripheral devices such as cameras are not considered, fault tolerance may not necessarily be high. On the other hand, if peripheral devices are made redundant in consideration of abnormalities in the peripheral devices, the manufacturing costs of the mobile object will increase, resulting in a higher sales price.

In order to solve the above problem, an objective of the present application is to provide a mobile object control device, a mobile object control method, and a program that enable the fault tolerance of an autonomous steering control mechanism to be improved while suppressing an increase in cost. The present invention contributes to the development of sustainable transportation systems.

A mobile object control device, a mobile object control method, and a program according to the present invention adopt the following configurations.

(1): According to an aspect of the present invention, there is provided a mobile object control device including: a recognition part configured to recognize a surrounding situation of a mobile object; a first steering control device configured to control steering of the mobile object; and a second steering control device configured to control the steering of the mobile object in place of the first steering control device, wherein the first steering control device controls the steering of the mobile object so that a lane in which the mobile object is traveling is kept based on external environment information indicating a result of recognizing the surrounding situation in the recognition part, and wherein the second steering control device controls a steering device for implementing the steering of the mobile object based on predicted information predicted in relation to the steering of the mobile object.

(2): In the above-described aspect (1), the second steering control device may include a first storage part for saving lane information about the lane in which the mobile object is traveling during a predetermined period, the lane information being information included in the external environment information, and the second steering control device may control the steering of the mobile object based on the lane information during the predetermined period saved in the first storage part.

(3): In the above-described aspect (1), the first steering control device may determine a control input for the steering device according to a technique of model predictive control (MPC).

(4): In the above-described aspect (3), the second steering control device may include a second storage part for saving a predicted value of a magnitude of the steering calculated in the model predictive control by the first steering control device during a predetermined period, and the second steering control device may determine the magnitude of the steering in the steering device based on the predicted value of the predetermined period saved in the second storage part.

(5): In the above-described aspect (1), the steering device may include an operation part configured to receive a steering operation of a driver, the mobile object control device may control the mobile object in one of a first control state in which the driver is required to grip the operation part and a second control state in which the driver is not required to grip the operation part, and the second steering control device may output control information for controlling a magnitude of the steering of the mobile object to the steering device when the mobile object is in the second control state.

(6): In the above-described aspect (1), the steering device may include a first steering processing device configured to supply a first driving force to a steering mechanism of the mobile object based on a control input from the first steering control device; and a second steering processing device configured to supply a second driving force to the steering mechanism based on a control input from the second steering control device, the first steering control device and the first steering processing device may operate with power supplied from a first power supply, and the second steering control device and the second steering processing device may operate with power supplied from a second power supply.

(7): In the above-described aspect (6), the steering device may include an operation part configured to receive a steering operation of a driver, and the supply of the second driving force may be continued until the driver starts an operation on the operation part, until a predetermined time elapses from an end timing of the steering control of the first steering control device, or until the mobile object moves a predetermined distance from the end timing of the steering control of the first steering control device.

(8): According to another aspect of the present invention, there is provided a mobile object control method for use in a mobile object control device including a recognition part configured to recognize a surrounding situation of a mobile object, a first steering control device configured to control steering of the mobile object, and a second steering control device configured to control the steering of the mobile object in place of the first steering control device, the mobile object control method including: controlling, by the first steering control device, the steering of the mobile object so that a lane in which the mobile object is traveling is kept based on external environment information indicating a result of recognizing the surrounding situation in the recognition part, and controlling, by the second steering control device, a steering device for implementing the steering of the mobile object based on predicted information predicted in relation to the steering of the mobile object.

(9): According to yet another aspect of the present invention, there is provided a program for causing a mobile object control device including a recognition part configured to recognize a surrounding situation of a mobile object, a first steering control device configured to control steering of the mobile object, and a second steering control device configured to control the steering of the mobile object in place of the first steering control device to execute: a process in which the first steering control device controls the steering of the mobile object so that a lane in which the mobile object is traveling is kept based on external environment information indicating a result of recognizing the surrounding situation in the recognition part, and a process in which the second steering control device controls a steering device for implementing the steering of the mobile object based on predicted information predicted in relation to the steering of the mobile object.

According to the above-described aspects (1) to (9), it is possible to improve the fault tolerance of an autonomous steering control mechanism while suppressing an increase in cost.

### BRIEF DESCRIPTION OF THE DRAWINGS

FIG. 1 is a configuration diagram of a vehicle system 1 including a mobile object control device according to a first embodiment.

FIG. 2 is a diagram showing an example of a functional configuration of an autonomous driving control device 100 according to the first embodiment.

FIG. 3 is a flowchart showing an example of a flow of a process performed by a third controller 180A in backup control according to the first embodiment.

FIG. 4 is a diagram showing a flow in which autonomous driving control degenerates from main control to backup control while a vehicle is traveling on a curved road according to the first embodiment.

FIG. 5 is a diagram showing an example of a functional configuration of an autonomous driving control device 100 according to a second embodiment.

FIG. 6 is a flowchart showing an example of a flow of a process performed by a third controller 180B in backup control according to the second embodiment.

### DETAILED DESCRIPTION OF THE INVENTION

### First Embodiment

Hereinafter, embodiments of a mobile object control device, a mobile object control method, and a program of the present invention will be described with reference to the drawings. Hereinafter, an embodiment in which an example of a mobile object is a vehicle and the mobile object control device is applied to an autonomous driving vehicle will be described as an example. For example, autonomous driving is a process of executing driving control by automatically controlling one or both of the vehicle's steering and speed. For example, the above-described driving control may include various types of driving control such as a lane keeping assistance system (LKAS), automated lane change (ALC), adaptive cruise control system (ACC), traffic jam pilot (TJP), and collision mitigation brake system (CMBS). In an autonomous driving vehicle, driving control (so-called manual driving) may be executed by a manual operation of a user (e.g., an occupant) of the vehicle. In addition to vehicles, the mobile object may include, for example, a watercraft that can move on the ground (on the road) like a hovercraft, an aircraft that can travel on the road, a stand-up vehicle having a motive power unit, and the like.

### [Overall Configuration]

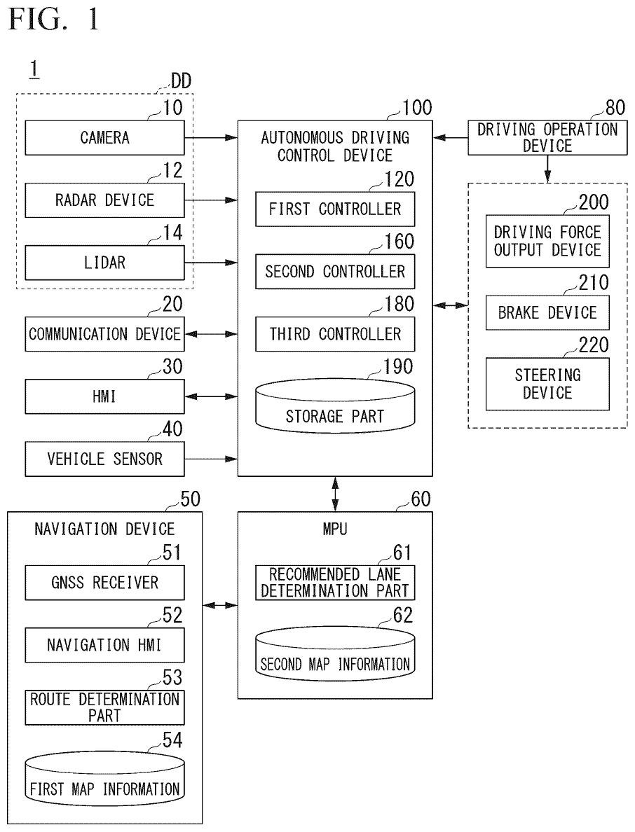

FIG. 1 is a configuration diagram of a vehicle system 1 including a mobile object control device according to a first embodiment. A vehicle on which the vehicle system 1 is mounted is, for example, a vehicle such as a two-wheeled vehicle, a three-wheeled vehicle, or a four-wheeled vehicle or a micromobility, and a drive source thereof is an internal combustion engine such as a diesel engine or a gasoline engine, an electric motor, or a combination thereof. The electric motor operates using electric power generated by a power generator connected to the internal combustion engine or electric power that is supplied when a battery (power storage) such as a secondary battery or a fuel cell is discharged.

For example, the vehicle system 1 includes a camera 10, a radar device 12, a light detection and ranging (LIDAR) 14, a communication device 20, a human machine interface (HMI) 30, a vehicle sensor 40, a navigation device 50, a map positioning unit (MPU) 60, a driving operation device 80, an autonomous driving control device 100, a driving force output device 200, a brake device 210, and a steering device 220. Such devices and equipment are connected to each other by a multiplex communication line such as a controller area network (CAN) communication line, a serial communication line, a wireless communication network, or the like. In addition, the configuration shown in FIG. 1 is merely an example and some of the constituent elements may be omitted or other constituent elements may be further added. A combination of the camera 10, the radar device 12, and the LIDAR 14 is an example of a “detection device DD.”

For example, the camera 10 is a digital camera using a solid-state imaging element such as a charge-coupled device (CCD) or a complementary metal oxide semiconductor (CMOS). The camera 10 is attached to any location on the vehicle on which the vehicle system 1 is mounted. When the view in front of the vehicle is imaged, the camera 10 is attached to an upper part of a front windshield, a rear surface of a rearview mirror, a front part of a vehicle body, or the like. When the view to the rear of the vehicle is imaged, the camera 10 is attached to an upper part of a rear windshield, a back door, or the like. When the views to the sides of the vehicle are imaged, the camera 10 is attached to door mirrors or the like. For example, the camera 10 periodically and iteratively images the surroundings of the vehicle. The camera 10 may be a stereo camera.

The radar device 12 radiates radio waves (radar) such as millimeter waves around the vehicle and detects at least a position of an object (a distance from the object and a direction of the object) by detecting radio waves (reflected waves) reflected by the object near the vehicle. The radar device 12 is attached to any location on the vehicle. The radar device 12 may detect a position and a speed of the object in a frequency-modulated continuous wave (FM-CW) scheme.

The LIDAR 14 radiates light to the vicinity of the vehicle and measures scattered light. The LIDAR 14 detects a distance from an object based on time from light emission to light reception. The radiated light is, for example, pulsed laser light. The LIDAR 14 is attached to any location on the vehicle.

The communication device 20, for example, communicates with another vehicle located in the vicinity of the vehicle, a terminal device of a user using the vehicle, or various types of server devices using, for example, a cellular network, a Wi-Fi network, Bluetooth (registered trademark), dedicated short-range communication (DSRC), a local area network (LAN), a wide area network (WAN), a network such as the Internet, or the like.

The HMI 30 outputs various types of information to occupants (including the driver) of the vehicle and receives input operations from the occupants. The HMI 30 includes, for example, various types of display devices, a speaker, a buzzer, a touch panel, a switch, a key, a microphone, and the like.

The vehicle sensor 40 includes a vehicle speed sensor configured to detect the speed of the vehicle, an acceleration sensor configured to detect acceleration, a yaw rate sensor configured to detect a yaw rate (e.g., a rotational angular velocity around a vertical axis passing through the center of gravity of the vehicle), and a direction sensor configured to detect a direction of the vehicle. Moreover, the vehicle sensor 40 may include a position sensor configured to detect the position of the vehicle. The position sensor is, for example, a sensor configured to acquire position information (longitude/latitude information) from a Global Positioning System (GPS) device. Moreover, the position sensor may be a sensor configured to acquire position information using a global navigation satellite system (GNSS) receiver 51 of the navigation device 50. The vehicle sensor 40 may derive the speed of the vehicle from a position information difference (i.e., a distance) at a predetermined time in the position sensor. Moreover, the vehicle sensor 40 may be provided with a sensor for acquiring weather conditions (e.g., a humidity sensor or a rain sensor). A detection result of the vehicle sensor 40 is output to the autonomous driving control device 100.

For example, the navigation device 50 includes the GNSS receiver 51, a navigation HMI 52, and a route determination part 53. The navigation device 50 stores first map information 54 in a storage device such as a hard disk drive (HDD) or a flash memory. The GNSS receiver 51 identifies a position of the vehicle based on a signal received from a GNSS satellite. The position of the vehicle may be identified or complemented by an inertial navigation system (INS) using an output of the vehicle sensor 40. The navigation HMI 52 includes a display device, a speaker, a touch panel, a key, and the like. The GNSS receiver 51 may be provided in the vehicle sensor 40. The navigation HMI 52 may be partly or wholly shared with the above-described HMI 30. For example, the route determination part 53 determines a route (hereinafter referred to as a route on a map) from the position of the vehicle identified by the GNSS receiver 51 (or any input position) to a destination input by the occupant using, for example, the navigation HMI 52 with reference to the first map information 54 or the like. The first map information 54 is, for example, information in which a road shape is expressed by a link indicating a road (an example of a movement route) and nodes connected by the link. The first map information 54 may include point of interest (POI) information, and the like. The route on the map is output to the MPU 60. The navigation device 50 may provide route guidance using the navigation HMI 52 based on the determined route on the map. The navigation device 50 may transmit a current position and a destination to a navigation server via the communication device 20 and acquire a route equivalent to the route on the map from the navigation server. The navigation device 50 outputs the determined route on the map to the MPU 60.

The MPU 60 includes, for example, a recommended lane determination part 61, and holds second map information 62 in a storage device such as an HDD or a flash memory. The recommended lane determination part 61 divides the route on the map provided from the navigation device 50 into a plurality of blocks (e.g., divides the route every 100 [m] in a travel direction of the vehicle), and determines a recommended lane for each block with reference to the second map information 62. The recommended lane determination part 61 determines in what lane numbered from the left the vehicle will travel. The recommended lane determination part 61 determines the recommended lane so that the vehicle can travel along a reasonable route for traveling to a branching destination when there is a branch point on the route on the map.

The second map information 62 has higher accuracy than the first map information 54. The second map information 62 includes, for example, the number of lanes (the number of movement routes), a type and shape of a road marking (hereinafter referred to as a marking), information about a center of a lane or information about a road boundary, and the like. The second map information 62 may include information about whether or not the road boundary is a boundary (physical boundary) including a structure through which the vehicle cannot pass (including crossing or contacting). Examples of physical boundaries include guardrails, curbs, median strips, fences, sidewalls of tunnels, nose targets (soft noses and hard noses), and the like. The term “passage is impossible” may include the presence of steps that are low enough to pass if the vehicle is allowed to vibrate, which would not normally occur. The second map information 62 may include road shape information, traffic regulation information, address information (addresses and postal codes), facility information, parking lot information, telephone number information, and the like. The road shape information is, for example, the curvature of a road (which may be rephrased as a radius of curvature; the same is true below), a road width, a road surface gradient, a branch point, a merge point, and the like. The second map information 62 may be updated at any time by the communication device 20 communicating with an external device. The first map information 54 and the second map information 62 may be integrated and provided as map information. Moreover, the map information may be stored in the storage part 190.

The driving operation device 80 includes, for example, a steering wheel, an accelerator pedal, and a brake pedal. Moreover, the driving operation device 80 may include a shift lever, a variant steering wheel, a joystick, and other operation devices. For example, an operation detection part configured to detect an amount of operation on the operation device by the driver or the presence or absence of operation is attached to each operation device in the driving operation device 80. The operation detection part detects, for example, a steering angle and steering torque of the steering wheel, an amount of depression of the accelerator pedal or the brake pedal, and the like. Also, the operation detection part outputs the detection result to the autonomous driving control device 100, or to one or all of the driving force output device 200, the brake device 210, and the steering device 220.

The autonomous driving control device 100 executes various types of control belonging to autonomous driving with respect to the vehicle. The autonomous driving control device 100 includes, for example, a first controller 120, a second controller 160, a third controller 180A, and a storage part 190. Each of the first controller 120, the second controller 160, and the third controller 180A is implemented, for example, by a hardware processor such as a central processing unit (CPU) executing a program (software). Moreover, some or all of the above constituent elements may be implemented by hardware (including a circuit; circuitry) such as a large-scale integration (LSI) circuit, an application-specific integrated circuit (ASIC), a field-programmable gate array (FPGA), a graphics processing unit (GPU), or a system on chip (SOC) or may be implemented by software and hardware in cooperation. The above-described program may be pre-stored in a storage device (a storage device including a non-transitory storage medium) such as an HDD or a flash memory of the autonomous driving control device 100 or may be stored in a removable storage medium such as a digital versatile disc (DVD), a compact disc-read-only memory (CD-ROM), or a memory card and installed in the storage device of the autonomous driving control device 100 when the storage medium (the non-transitory storage medium) is mounted on a drive device, a card slot, or the like.

The storage part 190 may be implemented by the above-described various types of storage devices, an electrically erasable programmable read-only memory (EEPROM), a read-only memory (ROM), a random-access memory (RAM), or the like. The storage part 190 stores, for example, various types of information in embodiments, programs, and the like. Moreover, the storage part 190 may store map information (e.g., the first map information 54 and the second map information 62).

The driving force output device 200 outputs a driving force (torque) for enabling the vehicle to travel to driving wheels. For example, the driving force output device 200 includes a combination of an internal combustion engine, an electric motor, a transmission, and the like, and an electronic control unit (ECU) that controls the internal combustion engine, the electric motor, the transmission, and the like. The ECU controls the above-described constituent elements in accordance with information input from the second controller 160 or information input from the accelerator pedal of the driving operation device 80.

For example, the brake device 210 includes a brake caliper, a cylinder configured to transfer hydraulic pressure to the brake caliper, an electric motor configured to generate hydraulic pressure in the cylinder, and a brake ECU. The brake ECU controls the electric motor in accordance with the information input from the second controller 160 or the information input from the brake pedal of the driving operation device 80 so that brake torque according to a braking operation is output to each wheel. The brake device 210 may include a mechanism configured to transfer the hydraulic pressure generated according to an operation on the brake pedal to the cylinder via a master cylinder as a backup. The brake device 210 is not limited to the above-described configuration and may be an electronically controlled hydraulic brake device configured to control an actuator in accordance with information input from the second controller 160 and transfer the hydraulic pressure of the master cylinder to the cylinder.

For example, the steering device 220 includes a steering ECU and an electric motor. For example, the electric motor changes directions of steerable wheels by applying a force to a rack and pinion mechanism. The steering ECU drives the electric motor in accordance with the information input from the second controller 160 or the information input from the steering wheel of the driving operation device 80 to change the directions of the steerable wheels.

### [Autonomous Driving Control]

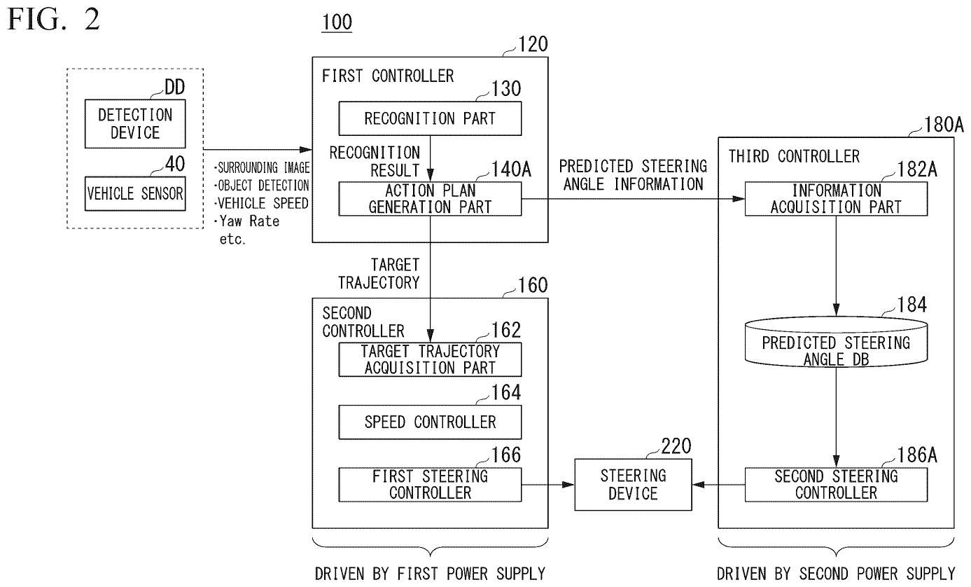

FIG. 2 is a diagram showing an example of a functional configuration of the autonomous driving control device 100 according to the first embodiment. The first controller 120 includes, for example, a recognition part 130 and an action plan generation part 140A. The first controller 120 implements, for example, a function of artificial intelligence (AI) and a function of a predetermined model in parallel. For example, an “intersection recognition” function may be implemented by executing intersection recognition based on deep learning or the like and recognition based on previously given conditions (signals, road signs, or the like, with which pattern matching is possible) in parallel and performing comprehensive evaluation by assigning scores to both recognitions. Thereby, the reliability of autonomous driving is secured. Moreover, the first controller 120 executes control related to autonomous driving of the vehicle based on, for example, instructions from the MPU 60, or the like.

The recognition part 130 recognizes a surrounding situation of the vehicle based on a detection result of the detection device DD (information input from the camera 10, the radar device 12, and the LIDAR 14). For example, the recognition part 130 performs a sensor fusion process on some or all of the detection results of the camera 10, the radar device 12, and the LIDAR 14 to recognize states of the position (relative position), size, speed (relative speed), acceleration, and the like of a target (an object) located in the vicinity of the vehicle (within a predetermined distance from the vehicle). Targets recognized by the recognition part 130 may include, for example, obstacles such as signs temporarily placed on the road and traffic participants such as other vehicles, pedestrians, bicycles, and the like in addition to physical boundaries (e.g., physical boundaries included in map information) that divide the road (movement path). The position of the target, for example, is recognized as a position on absolute coordinates with a representative point (the center of gravity, the center of a drive shaft, or the like) of the vehicle as the origin, and is used for control. The position of the target may be indicated by a representative point such as the center of gravity or a corner of the target or may be indicated by an area that has been represented. The “state” of the target may include, for example, the acceleration or jerk of the mobile object, or the “action state” (e.g., whether or not another vehicle is changing lanes or is about to change lanes) when the target is a mobile object such as another vehicle.

Moreover, the recognition part 130 recognizes, for example, a stop line, a red light, a toll booth, other road events, road signs, and markings drawn on the road (e.g., speed limits), and the like.

The action plan generation part 140A generates an action plan for causing the vehicle to travel (move) according to autonomous driving based on a recognition result of the recognition part 130 or the like. For example, the action plan generation part 140A generates a future target trajectory (target travel route) along which the vehicle will automatically travel (independently of the driver's operation) so that the vehicle can generally travel in the recommended lane determined by the recommended lane determination part 61 and further take an action for a surrounding situation of the vehicle based on a nearby road shape, or the like based on the recognition result of the recognition part 130 or a current position of the vehicle acquired from map information. For example, the target trajectory includes a speed element. For example, the target trajectory is represented by sequentially arranging points (trajectory points) at which the vehicle is required to arrive. The trajectory points are points at which the vehicle is required to arrive for each predetermined traveling distance (e.g., about several meters [m]) in a distance along a road. In addition, a target speed and target acceleration for each predetermined sampling time (e.g., about 0.x [sec] where x is a decimal number) are generated as parts of the target trajectory. Moreover, the trajectory point may be a position where the vehicle is required to arrive at the sampling time for each predetermined sampling time. In this case, information of the target speed and the target acceleration is represented by an interval between the trajectory points.

The action plan generation part 140A may set an autonomous driving event when the target trajectory is generated. The events include, for example, a lane departure suppression event for causing the vehicle to travel so that the vehicle is prevented from departing the lane, a constant speed travel event in which the vehicle travels in the same lane at a constant speed, a tracking travel event for causing the vehicle to track another vehicle located within a predetermined distance (e.g., within 100 [m]) in front of the vehicle and closest to the vehicle, a lane change event for causing the vehicle to make a lane change from a vehicle lane to an adjacent lane, a branching event for causing the vehicle to move to a lane in a destination direction at a branch point of a road, a merging event for causing the vehicle to move to a lane of a main road at a merge point, a takeover event for ending autonomous driving and switching driving to manual driving, and the like. Moreover, the events may include, for example, an overtaking event in which the vehicle first makes a lane change to an adjacent lane, overtakes the preceding vehicle in the adjacent lane, and then makes a lane change to the original lane again, an avoidance event for causing the vehicle to perform at least one of braking and steering to avoid an obstacle in front of the vehicle, and the like.

Moreover, the action plan generation part 140A, for example, may change an event already determined for a current segment to another event or set a new event for the current segment, in accordance with a surrounding situation of the vehicle recognized when the vehicle is traveling. Moreover, the action plan generation part 140A may change an event already set for the current segment to another event or set a new event for the current segment, in accordance with an operation of the occupant on the HMI 30. The action plan generation part 140A generates a target trajectory according to the set event.

The second controller 160 controls the driving force output device 200, the brake device 210, and the steering device 220 so that the vehicle passes through the target trajectory generated by the action plan generation part 140A at a scheduled time.

The second controller 160 includes, for example, a target trajectory acquisition part 162, a speed controller 164, and a first steering controller 166. The target trajectory acquisition part 162 acquires information about a target trajectory (trajectory points) generated by the action plan generation part 140A and causes a memory (not shown) to store the information. The speed controller 164 controls the driving force output device 200 or the brake device 210 based on the speed element associated with the target trajectory stored in the memory. The first steering controller 166 controls the steering device 220 in accordance with a degree of curvature of the target trajectory stored in the memory. The processes of the speed controller 164 and the first steering controller 166, for example, are implemented by a combination of feedforward control and feedback control. As an example, the first steering controller 166 executes a combination of feedforward control according to the curvature of the road in front of the vehicle and feedback control based on the deviation from the target trajectory.

When the autonomous driving control of the first controller 120 and the second controller 160 has failed, the third controller 180A controls the steering of the vehicle in place of the first controller 120 and the second controller 160 during a predetermined period. Hereinafter, the autonomous driving control of the first controller 120 and the second controller 160 will be referred to as “main control,” and the autonomous driving control of the third controller 180A will be referred to as “backup control.” The predetermined period of the backup control (hereinafter referred to as the “backup control period”) is a period from the failure of the main control to the handover of the driving operation of the vehicle to the driver. The third controller 180A executes backup control, such that the operation of the vehicle is stabilized in the case of a main control failure and the driving operation of the vehicle can be handed over to the driver more safely.

More specifically, the steering device 220 includes a first electric power steering (EPS) device that is driven by a first power supply and a second EPS device that is driven by a second power supply. Both the first EPS device and the second EPS device are devices that supply a driving force to the steering mechanism of the steering device 220. The first EPS device is controlled by a first steering controller 166 of the second controller 160, and the second EPS device is controlled by a second steering controller 186A of the third controller 180A. Although the first power supply, the second power supply, and the second steering controller 186A will be described below, it is possible to continue autonomous driving control according to the second EPS device that is driven by the second power supply even if the first power supply fails when the steering device 220 includes two EPS devices that are driven by different power supplies. The first EPS device is an example of a “first steering processing device,” and the second EPS device is an example of a “second steering processing device.” Moreover, the driving force supplied by first EPS to the steering mechanism is an example of a “first driving force,” and the driving force supplied by second EPS to the steering mechanism is an example of a “second driving force.”

### [Power Supply Redundancy]

As shown in FIG. 2, the first controller 120, the second controller 160, the detection device DD, and the vehicle sensor 40 for use in main control are driven by power supplied from a first power supply (not shown). On the other hand, the third controller 180A is driven by power supplied from a second power supply (not shown). The second power supply is a power supply different from the first power supply and operates independently without relying on the first power supply. In this way, when a device for use in the main control and a device for use in backup control are driven with separate power supplies, the autonomous driving control device 100 of the embodiment can provide redundancy for autonomous driving control together with the power supply device.

### [Backup Control]

The third controller 180A performs steering angle control (backup control) when the second controller 160 has failed. The third controller 180A includes, for example, an information acquisition part 182A, a predicted steering angle information DB 184, and a second steering controller 186A. The information acquisition part 182A acquires information necessary for backup control from the main control side. More specifically, the information acquisition part 182A acquires predicted steering angle information indicating a predicted value (predicted steering angle) of the vehicle's steering angle at a future time (hereinafter referred to as a “specific time”) that is a predetermined time after the current time from the action plan generation part 140A. The information acquisition part 182A saves the acquired predicted steering angle information in the predicted steering angle information DB 184.

Moreover, for this backup control, the action plan generation part 140A acquires predicted steering angle information at any time based on the generated action plan (including the target trajectory) and supplies the predicted steering angle information to the third controller 180A. For example, the action plan generation part 140A may calculate the predicted steering angle of the vehicle at the specific time under the assumption that the vehicle will travel along the target trajectory while maintaining its current vehicle speed and lane. For example, the action plan generation part 140A may be configured to calculate the predicted steering angle using a technique of model predictive control (MPC). According to model predictive control, by having a prediction model (in other words, a control target model) that appropriately represents the dynamic characteristics (dynamics) of the control target within the controller, it is possible to predict a future behavior of the control target during a certain finite segment from the current time.

The predicted steering angle information DB 184 is a database for storing predicted steering angle information supplied from the first controller 120 at any time in the third controller 180A. The predicted steering angle information DB 184 saves the predicted steering angle value indicated by the predicted steering angle information supplied from the first controller 120 and a specific time corresponding to the predicted steering angle in association with each other. Moreover, when the provision of a predicted steering angle is required along with the designation of a specific time from the second steering controller 186A, the predicted steering angle information DB 184 extracts the value of the predicted steering angle associated with the specific time from the database and supplies the extracted value to the second steering controller 186A. The predicted steering angle information DB 184 is an example of a “second storage part.”

The second steering controller 186A performs backup control when autonomous driving control based on the main control fails, based on the predicted steering angle information stored in the predicted steering angle information DB 184. For example, the second steering controller 186A acquires a value of the predicted steering angle corresponding to the current time from the predicted steering angle information DB 184 and controls the steering device 220 to maintain the acquired steering angle. At this time, the third controller 180A may be configured to control the driving force output device 200 or the brake device 210 as necessary.

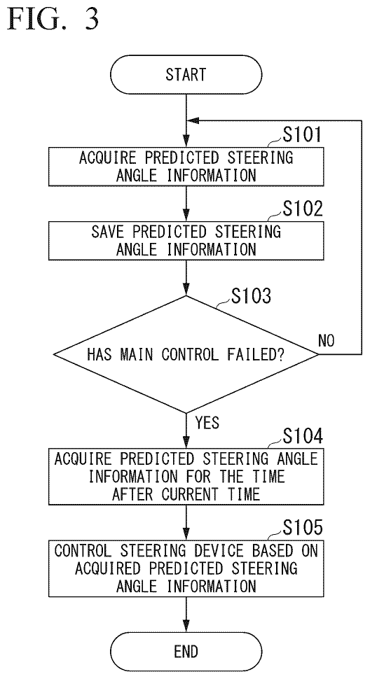

FIG. 3 is a flowchart showing an example of a flow of a process performed by the third controller 180A in backup control according to the first embodiment. First, the information acquisition part 182A acquires predicted steering angle information from the first controller 120 (S101). The information acquisition part 182A saves the predicted steering angle information acquired in step S101 in the predicted steering angle information DB 184 (S102). In addition, because the predicted steering angle information is continuously supplied in a situation in which the first controller 120 is functioning normally, the information acquisition part 182A iteratively acquires and stores the predicted steering angle information at any time. Moreover, the information acquisition part 182A may be configured to save the latest predicted steering angle information in the predicted steering angle information DB 184 and delete past predicted steering angle information that is older than the current time from predicted steering angle information held in the predicted steering angle information DB 184.

Subsequently, the second steering controller 186A determines whether or not autonomous driving control based on the main control has failed (S103). For example, the third controller 180A may determine that the main control has failed based on an event such as a loss of communication with the first controller 120 or the second controller 160 or a failure of the first power supply. When it is determined that the main control has not failed (is operating normally), the process returns to step S101, and the acquisition and saving of predicted steering angle information are iteratively executed (S101 and S102).

On the other hand, when it is determined that the main control has failed in step S103, the second steering controller 186A acquires predicted steering angle information from the predicted steering angle information DB 184 for the time after the current time (S104). The second steering controller 186A controls the steering device 220 based on the predicted steering angle information acquired in step S104 (S105). More specifically, the second steering controller 186A controls the steering device 220 so that the steering angle matches the predicted steering angle at each point in time, at least until the driver hands over the driving operation of the vehicle.

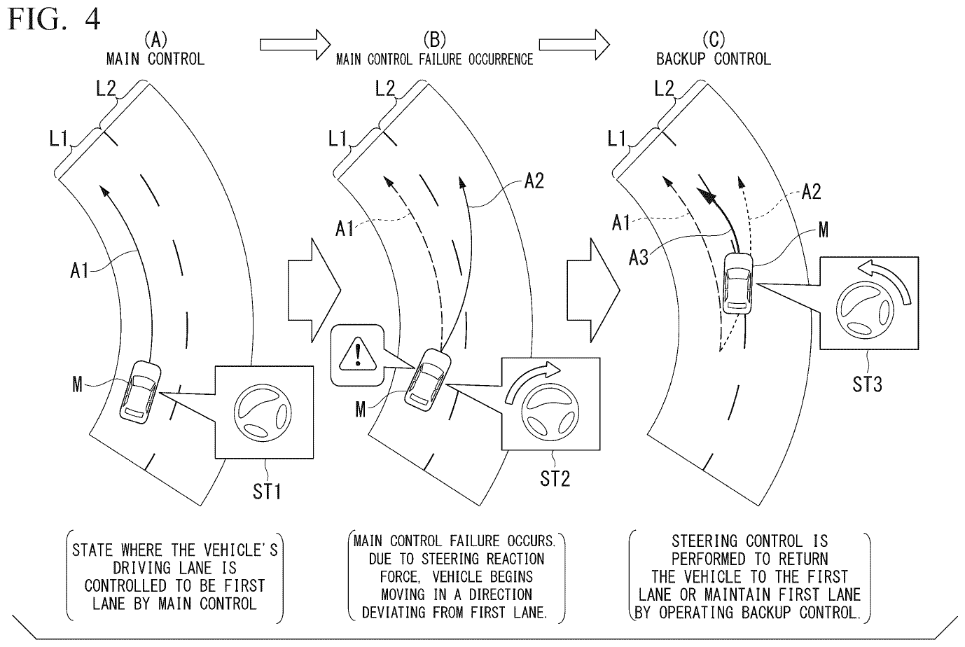

FIG. 4 is a diagram showing a flow in which autonomous driving control degenerates from main control to backup control while the vehicle is traveling on a curved road according to the first embodiment. FIG. 4 shows a travel direction and steering state of the vehicle M at each of timings (A), (B), and (C). Solid arrows A1 to A3 indicate courses of the vehicle M assumed at timings, while dashed arrows A1 to A3 correspond to the solid arrows A1 to A3 and indicate courses of the vehicle M assumed at previous timings at respective timings. Moreover, steering wheel icons ST1 to ST3 represent control states of the steering angle of the steering device 220.

First, situation (A) is a state in which the main control is functioning normally, and is a situation in which the steering device 220 is controlled so that the steering angle of the vehicle M is the steering angle necessary to prevent the vehicle M from deviating from the course A1. The curved road in the example of FIG. 4 has a turning center in the left direction of the vehicle M. Therefore, in situation (A), the steering angle of the steering device 220 is tilted by the main control in a left rotation direction from the center position by an angle corresponding to the vehicle speed of the vehicle M and the curvature of the first lane L1 (steering state ST1). In situation (A), because the main control is functioning normally, the driver does not need to grip the steering wheel. This control state is an example of a “first control state.”

Next, situation (B) is a situation in which a failure occurs in the main control for some factor after a timing of situation (A). In this situation, a control force that attempts to maintain the steering angle in the left rotation direction required for traveling in the first lane L1 is lost, and the steering angle of the steering device 220 attempts to return to the center position due to the steering reaction force (steering state ST2). Therefore, if this state continues, it is assumed that the vehicle M will take the course A2 while deviating from the first lane L1 and entering a second lane L2.

Next, situation (C) is a situation in which, after a timing of situation (B), the backup control is activated and steering control of the steering device 220 is resumed. In this situation, the steering angle of the vehicle M is controlled based on predicted steering angle information (steering state ST3). Backup control continues until the driver hands over the driving operation of the vehicle M (e.g., 2 to 3 sec). Thereby, it is assumed that the vehicle M takes the course A3 closer to the original first lane L1 than the course A2 assumed in situation (B). In other words, backup control enables the vehicle M to hand over the driving operation to the driver in a safer environment, even if the main control fails. After the driving operation is handed over to the driver, the vehicle is controlled in a form in which the driver is required to grip the steering wheel. This control state is an example of a “second control state.”

### Second Embodiment

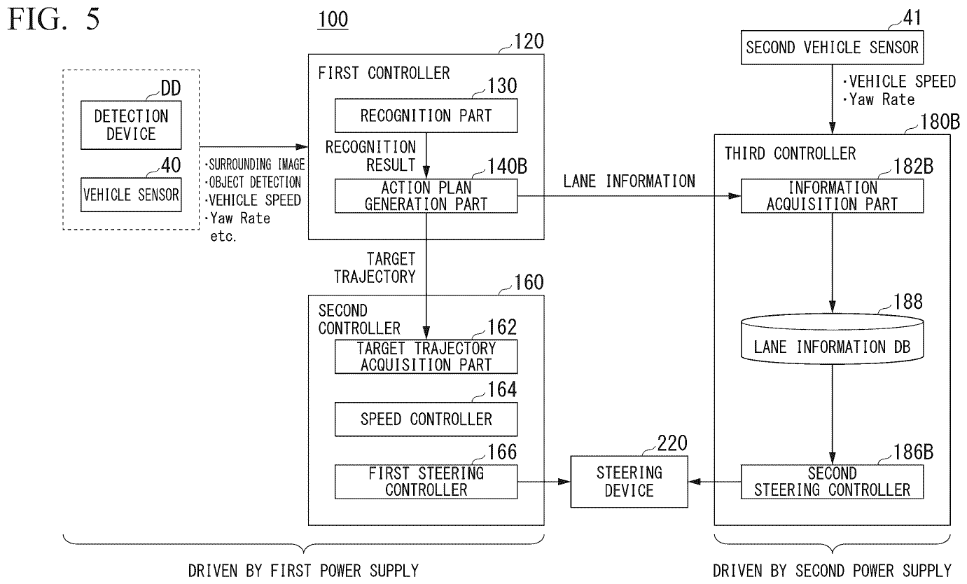

FIG. 5 is a diagram showing an example of a functional configuration of an autonomous driving control device 100 according to the second embodiment. The autonomous driving control device 100 of the second embodiment is different from the autonomous driving control device 100 of the first embodiment in that an action plan generation part 140B is provided instead of the action plan generation part 140A, a third controller 180B is provided instead of the third controller 180A, and a second vehicle sensor 41 is further provided. Moreover, the third controller 180B is different from the third controller 180A in that an information acquisition part 182B is provided instead of the information acquisition part 182A, a lane information DB 188 is provided instead of the predicted steering angle information DB 184, and a second steering controller 186B is provided instead of the second steering controller 186A. Other constituent elements are similar to those of the first embodiment. Differences from the first embodiment will be mainly described, and descriptions of constituent elements similar to those of the first embodiment will be omitted.

The action plan generation part 140B basically has functions similar to those of the action plan generation part 140A, but is different from the action plan generation part 140A in that lane information is supplied to the third controller 180B instead of the predicted steering angle information. Based on recognition results of the recognition part 130, the action plan generation part 140B acquires lane information (hereinafter referred to as “lane information”) corresponding to the vehicle's position at the above-described specific time as needed and supplies the information to the third controller 180B. The lane information may be, for example, extracted from the first map information 54, the second map information 62, or the like based on the vehicle's current position, or may be a lane recognition result of the recognition part 130 based on the output of the detection device DD.

The information acquisition part 182B acquires lane information from the action plan generation part 140B and saves the lane information in the lane information DB 188.

The lane information DB 188 is a database for storing lane information supplied from the first controller 120 at any time in the third controller 180B. The lane information DB 188 saves the lane information supplied from the first controller 120 and a specific time corresponding to the lane information in association with each other. Moreover, when the provision of lane information is requested along with the designation of the specific time from the second steering controller 186B, the lane information DB 188 extracts the lane information associated with the specific time from the database and supplies the lane information to the second steering controller 186B. The lane information DB 188 is an example of a “first storage part.”

The second steering controller 186B performs backup control of a case where autonomous driving control based on main control fails, based on the lane information stored in the lane information DB 188. For example, the second steering controller 186B acquires lane information corresponding to the current time from the lane information DB 188 and determines the steering angle based on the acquired lane information and information such as a vehicle speed and yaw rate detected by the second vehicle sensor 41 (hereinafter referred to as “vehicle sensor information”). The second steering controller 186B controls the steering device 220 to maintain the determined steering angle. In addition, at this time, the third controller 180B may be configured to control the driving force output device 200 or the brake device 210 as necessary, as in the case of the third controller 180A.

Moreover, the second vehicle sensor 41 is configured to be driven by the second power supply, like the third controller 180B. Thereby, even if the main control fails due to an abnormality in the first power supply, backup control can be activated by the second vehicle sensor 41.

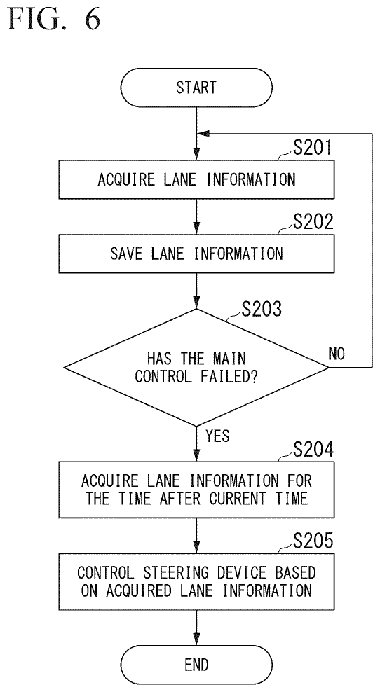

FIG. 6 is a flowchart showing an example of a flow of a process performed by the third controller 180B in backup control according to the second embodiment. First, the information acquisition part 182B acquires lane information from the first controller 120 (S201). The information acquisition part 182B stores the lane information acquired in step S201 in the lane information DB 188 (S202). In addition, because lane information is continuously supplied in a situation in which the first controller 120 is functioning normally, the information acquisition part 182B iteratively performs the acquisition and saving of lane information at any time. Moreover, the information acquisition part 182B may be configured to save the latest lane information in the lane information DB 188 and delete past lane information that is older than the current time from the lane information stored in the lane information DB.

Subsequently, the second steering controller 186B determines whether or not autonomous driving control based on the main control has failed (S203). For example, the third controller 180B may determine that the main control has failed based on the occurrence of an event such as a loss of communication with the first controller 120 or the second controller 160 or a failure of the first power supply. When it is determined that the main control has not failed (is operating normally) here, the process returns to step S201, and the acquisition and saving of the lane information are iteratively performed (S201 and S202).

On the other hand, when it is determined that the main control has failed in step S203, the second steering controller 186B acquires lane information from the lane information DB 188 for the time after the current time (S204). The second steering controller 186B controls the steering device 220 based on the lane information and vehicle sensor information acquired in step S204 (S205). More specifically, the second steering controller 186B calculates the required steering angle at each point in time based on lane information (curvature) and vehicle sensor information (a vehicle speed and a yaw rate), and controls the steering device 220 to match the required steering angle at each point in time, at least until the driving operation of the vehicle is handed over to the driver. In addition, it is only necessary for the required steering angle to be any angle that acts in a direction in which the lane departure of the vehicle is suppressed. For example, the required steering angle may be a steering angle required to return the vehicle to a driving lane in which the vehicle is traveling before the main control fails, or may be a steering angle required to cause the vehicle to maintain the driving lane in which the vehicle is traveling before the main control fails.

According to the above-described embodiment, it is possible to improve the fault tolerance of an autonomous steering control mechanism while suppressing an increase in cost. Also, the present invention contributes to the development of sustainable transportation systems.

In the above embodiment, the combination of the first controller 120 and the second controller 160 is an example of a “first steering control device,” and the third controllers 180A and 180B are an example of a “second steering control device.” Moreover, the steering device 220 is an example of a “steering device,” and the steering wheel of the steering device 220 is an example of an “operation part.”

The embodiment described above can be represented as follows.

A mobile object control device including:
a recognition part configured to recognize a surrounding situation of a mobile object;
a first steering control device configured to control steering of the mobile object;
a second steering control device configured to control the steering of the mobile object in place of the first steering control device;
a storage medium storing computer-readable instructions; and
a processor connected to the storage medium, the processor executing the computer-readable instructions to perform:
a process in which the first steering control device controls the steering of the mobile object so that a lane in which the mobile object is traveling is kept based on external environment information indicating a result of recognizing the surrounding situation in the recognition part, and
a process in which the second steering control device controls a steering device for implementing the steering of the mobile object based on predicted information predicted in relation to the steering of the mobile object.

### <Modification Example>

Although the first controller 120 and the second controller 160 have been separately described in the above embodiment, the first controller 120 and the second controller 160 may be configured as a single controller, or the functions of the first controller 120 and the second controller 160 may be configured to be divided into three or more controllers.

In the first embodiment, the case where the second steering controller 186A controls the steering device 220 so that the steering angle matches the predicted steering angle has been described. Moreover, in the first embodiment, the case where this predicted steering angle is the steering angle at a future timing assumed under the assumption that the main control will continue has been described. In contrast, the predicted steering angle may be calculated as a steering angle that causes the vehicle, which has deviated from its original path due to a failure of the main control, to return to the original path. For example, at each time point at which the predicted steering angle is calculated, the second steering controller 186A may, under predetermined assumptions, predict a behavior of the vehicle during a period from the occurrence of a failure of the main control to the activation of the backup control, under the assumption that the main control fails at that time point, and may calculate, as the predicted steering angle, a steering angle required to return the predicted traveling state of the vehicle to the original traveling state.

Although the case where a control value is determined when main control fails (e.g., S105 and S205) has been described in the above-described embodiment, the control value itself may be determined regardless of whether or not the main control has failed. For example, the second steering controllers 186A and 186B (hereinafter collectively referred to as 186) may determine a control value for constant backup control and supply the control value to the steering device 220. In this case, the steering device 220 may be configured to prioritize a control value of the first steering controller 166 in a situation in which control values are supplied from both the first steering controller 166 and the second steering controller 186B, and to use a control value of the second steering controller 186B in a situation in which the control value is supplied only from the second steering controller 186B.

Although a case where the backup control is performed during a period from the occurrence of the failure of the main control to the handover of the driving operation to the driver has been described in the above-described embodiment, the backup control may be configured to be performed during a period until a predetermined time elapses from the occurrence of the failure of the main control. In this case, the predetermined time is set to the time (e.g., 2 to 3 sec) that is expected to be required from the occurrence of the failure of the main control to the handover of the driving operation to the driver.

Although modes for carrying out the present invention have been described using embodiments, the present invention is not limited to the embodiments and various modifications and substitutions can also be made without departing from the scope and spirit of the present invention.

### EXPLANATION OF REFERENCES

1 Vehicle system
10 Camera
12 Radar device
14 Light detection and ranging (LIDAR)
20 Communication device
40 Vehicle sensor
41 Second vehicle sensor
50 Navigation Device
51 Global navigation satellite system (GNSS) receiver
52 Navigation HMI
53 Route determination part
54 First map information
61 Recommended lane determination part
62 Second map information
80 Driving operation device
100 Autonomous driving control device
120 First controller
130 Recognition part
140A, 140B Action plan generation part
160 Second controller
162 Target trajectory acquisition part
164 Speed controller
166 First steering controller
180A, 180B Third controller
182A, 182B Information acquisition part
186A, 186B Second steering controller
190 Storage part
200 Driving force output device
210 Brake device
220 Steering device

What is claimed is:

1. A mobile object control device comprising:
a recognition part configured to recognize a surrounding situation of a mobile object;
a first steering control device configured to control steering of the mobile object; and
a second steering control device configured to control the steering of the mobile object in place of the first steering control device,
wherein the first steering control device controls the steering of the mobile object so that a lane in which the mobile object is traveling is kept based on external environment information indicating a result of recognizing the surrounding situation in the recognition part, and
wherein the second steering control device controls a steering device for implementing the steering of the mobile object based on predicted information predicted in relation to the steering of the mobile object.

2. The mobile object control device according to claim 1,
wherein the second steering control device includes a first storage part for saving lane information about the lane in which the mobile object is traveling during a predetermined period, the lane information being information included in the external environment information, and
wherein the second steering control device controls the steering of the mobile object based on the lane information during the predetermined period saved in the first storage part.

3. The mobile object control device according to claim 1, wherein the first steering control device determines a control input for the steering device according to a technique of model predictive control (MPC).

4. The mobile object control device according to claim 3,
wherein the second steering control device includes a second storage part for saving a predicted value of a magnitude of the steering calculated in the model predictive control by the first steering control device during a predetermined period, and
wherein the second steering control device determines the magnitude of the steering in the steering device based on the predicted value of the predetermined period saved in the second storage part.

5. The mobile object control device according to claim 1,
wherein the steering device includes an operation part configured to receive a steering operation of a driver,
wherein the mobile object control device controls the mobile object in one of a first control state in which the driver is required to grip the operation part and a second control state in which the driver is not required to grip the operation part, and
wherein the second steering control device outputs control information for controlling a magnitude of the steering of the mobile object to the steering device when the mobile object is in the second control state.

6. The mobile object control device according to claim 1,
wherein the steering device includes
a first steering processing device configured to supply a first driving force to a steering mechanism of the mobile object based on a control input from the first steering control device; and
a second steering processing device configured to supply a second driving force to the steering mechanism based on a control input from the second steering control device,
wherein the first steering control device and the first steering processing device operate with power supplied from a first power supply, and
wherein the second steering control device and the second steering processing device operate with power supplied from a second power supply.

7. The mobile object control device according to claim 6,
wherein the steering device includes an operation part configured to receive a steering operation of a driver, and
wherein the supply of the second driving force is continued until the driver starts an operation on the operation part, until a predetermined time elapses from an end timing of the steering control of the first steering control device, or until the mobile object moves a predetermined distance from the end timing of the steering control of the first steering control device.

8. A mobile object control method for use in a mobile object control device including a recognition part configured to recognize a surrounding situation of a mobile object, a first steering control device configured to control steering of the mobile object, and a second steering control device configured to control the steering of the mobile object in place of the first steering control device, the mobile object control method comprising:
controlling, by the first steering control device, the steering of the mobile object so that a lane in which the mobile object is traveling is kept based on external environment information indicating a result of recognizing the surrounding situation in the recognition part, and
controlling, by the second steering control device, a steering device for implementing the steering of the mobile object based on predicted information predicted in relation to the steering of the mobile object.

9. A program for causing a mobile object control device including a recognition part configured to recognize a surrounding situation of a mobile object, a first steering control device configured to control steering of the mobile object, and a second steering control device configured to control the steering of the mobile object in place of the first steering control device to execute:
a process in which the first steering control device controls the steering of the mobile object so that a lane in which the mobile object is traveling is kept based on external environment information indicating a result of recognizing the surrounding situation in the recognition part, and
a process in which the second steering control device controls a steering device for implementing the steering of the mobile object based on predicted information predicted in relation to the steering of the mobile object.
